(19) United States
(12) Patent Application Publication
(10) Pub. No.: US 2025/0378140 A1
(43) Pub. Date: Dec. 11, 2025

(54) METHOD AND APPARATUS FOR CLASSIFYING ELECTRICAL LOADS, ELECTRONIC DEVICE, MEDIUM AND PRODUCT

(71) Applicants: GUANGDONG POWER GRID CO., LTD., Guangzhou (CN); Heyuan Power Supply Bureau Of Guangdong Power Grid Corporation, Heyuan (CN)

(72) Inventors: Yongqin LI, Heyuan (CN); Peijie LIU, Heyuan (CN); Shuiqiang ZOU, Heyuan (CN); Tuo ZENG, Heyuan (CN); Dingji ZENG, Heyuan (CN); Ying WENG, Heyuan (CN); Yulin CHEN, Heyuan (CN); Yuee WAN, Heyuan (CN); Jingfang YOU, Heyuan (CN); Jiangfeng QIAO, Heyuan (CN); Xiaolong BI, Heyuan (CN); Junhui CHEN, Heyuan (CN); Zhongchao ZHANG, Heyuan (CN); Xianchao ZHAI, Heyuan (CN)

(21) Appl. No.: 19/006,703

(22) Filed: Dec. 31, 2024

(30) Foreign Application Priority Data
Jun. 11, 2024 (CN) 202410747347.6

(51) Int. Cl. G06F 18/23213; G06F 18/241; H02J 3/00

(52) U.S. Cl. CPC G06F 18/23213; G06F 18/241; H02J 3/00; H02J 2203/20

(57) ABSTRACT

A method for classifying electrical loads includes: clustering and averaging to-be-classified load data according to a cluster algorithm based on a Pearson correlation coefficient to obtain a first daily load curve, where the to-be-classified load data includes a daily load curve in years; segmenting and averaging the to-be-classified load data according to a seasonal segmentation aggregation algorithm to obtain second daily load curves corresponding to different seasons; separately comparing a target daily load curve with daily load curve models corresponding to different load types to obtain a candidate classification result corresponding to the target daily load curve, where the target daily load curve is any one of the first daily load curve and the second daily load curves; and determining a target classification result corresponding to the to-be-classified load data according to the candidate classification result.

### CROSS-REFERENCE TO RELATED APPLICATION

This application claims priority to Chinese Patent Application No. 202410747347.6 filed Jun. 11, 2024, the disclosure of which is incorporated herein by reference in its entirety.

### TECHNICAL FIELD

Embodiments of the present disclosure relate to the technical field of classifying loads of power systems and, in particular, to a method and apparatus for classifying electrical loads, an electronic device, a medium and a product.

### BACKGROUND

With an increasing requirement for power in various industries of society, load data in a power system has become increasingly complex, resulting in the problems such as the continuous widening of a peak-to-valley difference of a daily load and the concentration of the peak power usage time. An effective method for classifying loads has become the key to solving these problems and ensuring the normal and stable operation of the power system. At present, load classification can be achieved through a mean-based feature representation method, but using this method to achieve the load classification may lose key information of the load data, resulting in relatively low classification accuracy.

### SUMMARY

The present disclosure provides a method and apparatus for classifying electrical loads, an electronic device, a medium and a product, thereby improving the accuracy of classifying the electrical loads.

In a first aspect, embodiments of the present disclosure provide a method for classifying electrical loads. The method includes the steps described below.

To-be-classified load data is clustered and averaged according to a cluster algorithm based on a Pearson correlation coefficient to obtain a first daily load curve, where the to-be-classified load data includes a daily load curve in years.

The to-be-classified load data is segmented and averaged according to a seasonal segmentation aggregation algorithm to obtain second daily load curves corresponding to different seasons.

A target daily load curve is separately compared with daily load curve models corresponding to different load types to obtain a candidate classification result corresponding to the target daily load curve, where the target daily load curve is any one of the first daily load curve and the second daily load curves.

A target classification result corresponding to the to-be-classified load data is determined according to the candidate classification result.

In a second aspect, embodiments of the present disclosure provide an apparatus for classifying electrical loads. The apparatus includes a first processing module, a second processing module, a comparison module and a classification result determination module.

The first processing module is configured to cluster and average to-be-classified load data according to a cluster algorithm based on a Pearson correlation coefficient to obtain a first daily load curve, where the to-be-classified load data includes a daily load curve in years.

The second processing module is configured to segment and average the to-be-classified load data according to a seasonal segmentation aggregation algorithm to obtain second daily load curves corresponding to different seasons.

The comparison module is configured to separately compare a target daily load curve with daily load curve models corresponding to different load types to obtain a candidate classification result corresponding to the target daily load curve, where the target daily load curve is any one of the first daily load curve and the second daily load curves.

The classification result determination module is configured to determine a target classification result corresponding to the to-be-classified load data according to the candidate classification result.

In a third aspect, embodiments of the present disclosure provide an electronic device. The electronic device includes at least one processor and a memory communicatively connected to the at least one processor.

The memory stores a computer program executable by the at least one processor to enable the at least one processor to perform the method according to the first aspect.

In a fourth aspect, embodiments of the present disclosure provide a computer-readable storage medium. The computer-readable storage medium is configured to store a computer instruction which, when executed by a processor, causes the processor to implement the method according to the first aspect.

In a fifth aspect, embodiments of the present disclosure provide a computer program product. The computer program product includes a computer program, where the computer program is configured to, when executed by a processor, implement the method according to the first aspect.

In the technical solution of the embodiment of the present disclosure, the to-be-classified load data is processed according to the cluster algorithm based on the Pearson correlation coefficient to obtain the first daily load curve, where the Pearson correlation coefficient focuses on a variation direction of a curve shape so that a similarity between load curves can be better measured; the to-be-classified load data is processed according to the seasonal segmentation aggregation algorithm to obtain the second daily load curves so that the compression and loss of data features can be reduced to a larger extent while dimensionality reduction is performed on the data; load classification is achieved through the combination of the two algorithms and the comprehensive consideration of the multi-feature models, thereby improving the accuracy of classifying the electrical loads.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

To illustrate solutions of embodiments of the present disclosure more clearly, drawings used in description of embodiments of the present disclosure are described hereinafter. Apparently, these drawings illustrate part of embodiments of the present disclosure. Those of ordinary skill in the art may obtain other drawings based on these drawings on the premise that no creative work is done.

FIG. 1 is a flowchart of a method for classifying electrical loads according to embodiment one of the present disclosure.

FIG. 2 is a flowchart of a method for classifying electrical loads according to embodiment two of the present disclosure.

FIG. 3 is a flowchart of a method for classifying electrical loads according to embodiment three of the present disclosure.

FIG. 4 is a schematic diagram illustrating results of clustering historical load data through k-means clustering based on a Pearson correlation coefficient according to embodiment three of the present disclosure.

FIG. 5 is a schematic diagram illustrating results of segmenting historical load data through a seasonal segmentation aggregation algorithm according to embodiment three of the present disclosure.

FIG. 6 is a schematic diagram of daily load curve models corresponding to load types according to embodiment three of the present disclosure.

FIG. 7 is a structure diagram of an apparatus for classifying electrical loads according to embodiment four of the present disclosure.

FIG. 8 is a diagram illustrating the structure of an electronic device for implementing any embodiment of the present disclosure.

### DETAILED DESCRIPTION

For a better understanding of solutions of the present disclosure by those skilled in the art, solutions in embodiments of the present disclosure are described clearly and completely hereinafter in conjunction with the drawings in embodiments of the present disclosure. Apparently, the embodiments described hereinafter are part, not all, of embodiments of the present disclosure. Based on embodiments of the present disclosure, all other embodiments obtained by those of ordinary skill in the art on the premise that no creative work is done are within the scope of the present disclosure.

It should be noted that the terms “first”, “second” and the like described in the present disclosure are used to distinguish between similar objects and are not necessarily used to describe a particular order or sequence. It is to be understood that the data used in this way is interchangeable where appropriate so that embodiments of the present disclosure described herein may also be implemented in a sequence not illustrated or described herein. Additionally, terms “include” and “have” and any variations thereof are intended to encompass a non-exclusive inclusion. For example, a process, method, system, product, or device that includes a series of steps or units not only includes the expressly listed steps or units but may also include other steps or units that are not expressly listed or are inherent to such process, method, product, or device.

### Embodiment One

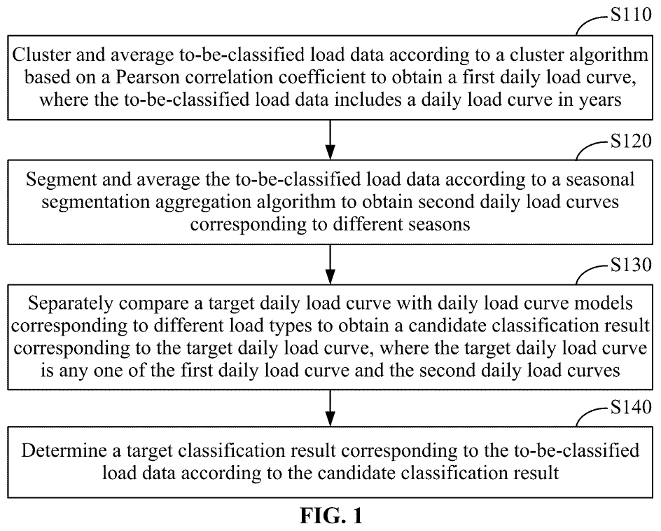

FIG. 1 is a flowchart of a method for classifying electrical loads according to embodiment one of the present disclosure. This embodiment may be applicable to the case of classifying electrical loads. The method may be performed by an apparatus for classifying electrical loads. The apparatus may be implemented in a form of software and/or hardware and integrated into an electronic device. Further, the electronic device includes, but is not limited to, a computer, a notebook computer, a smartphone and a server.

As shown in FIG. 1, the method includes S110 to S140.

In S110, to-be-classified load data is clustered and averaged according to a cluster algorithm based on a Pearson correlation coefficient to obtain a first daily load curve, where the to-be-classified load data includes a daily load curve in years.

The to-be-classified load data may be power usage data to be subjected to load classification. The to-be-classified load data may include a daily load curve formed by daily load data within one year. The daily load curve may be a curve for indicating a daily electrical load. The load classification may be understood as classifying user types that generate electrical loads. For example, the user type may include, but is not limited to, an office building, a school and a shopping mall.

The Pearson correlation coefficient may be understood as a statistical indicator for measuring a degree of correlation between two variables. The variables may be understood as the daily load curves included in the to-be-classified load data. The Pearson correlation coefficient may be a value between 1 and −1. The closer the value is to 1, the more correlated the variables are. The closer the value is to −1, the less correlated the variables are.

The cluster algorithm based on the Pearson correlation coefficient may be a k-means cluster algorithm based on the Pearson correlation coefficient.

In this step, the to-be-classified load data can be clustered according to the cluster algorithm based on the Pearson correlation coefficient to obtain multiple clusters, where each cluster among the multiple clusters includes multiple daily load curves, and a degree of correlation between daily load curves belonging to the same cluster is relatively large; a cluster including the most daily load curves is determined from the multiple clusters, and the daily load curves included in the determined cluster are averaged to obtain the first daily load curve.

The first daily load curve may be a daily load curve obtained after the to-be-classified load data is processed according to the cluster algorithm based on the Pearson correlation coefficient.

In S120, the to-be-classified load data is segmented and averaged according to a seasonal segmentation aggregation algorithm to obtain second daily load curves corresponding to different seasons.

The seasonal segmentation aggregation algorithm may be an algorithm for segmenting and aggregating the to-be-classified load data according to the different seasons.

The second daily load curve may be a daily load curve obtained after the to-be-classified load data is processed according to the seasonal segmentation aggregation algorithm. Different seasons correspond to their own second daily load curves. For example, spring, summer, autumn and winter correspond to second daily load curves, respectively.

In this step, the daily load curve included in the to-be-classified load data can be divided into four segments according to the seasonal segmentation aggregation algorithm and the different seasons of spring, summer, autumn and winter, where each segment includes a daily load curve within a season; a daily load curve included in each segment is averaged to obtain a second daily load curve corresponding to each segment.

In S130, a target daily load curve is separately compared with daily load curve models corresponding to different load types to obtain a candidate classification result corresponding to the target daily load curve, where the target daily load curve is any one of the first daily load curve and the second daily load curves.

The daily load curve model may be a curve model for determining a load type of the to-be-classified load data. The daily load curve model can be obtained through pre-training. A manner of training is not limited.

In an embodiment, a daily load curve model corresponding to each load type includes a first model obtained after historical load data under the corresponding load type is trained according to the cluster algorithm and second models corresponding to the different seasons obtained after the historical load data is trained according to the seasonal segmentation aggregation algorithm.

The first daily load curve is compared with the first model, and a second daily load curve among the second daily load curves is compared with a second model corresponding to the same season among the second models.

In the embodiment of the present disclosure, the daily load curve model corresponding to each load type may include a first model and four second models corresponding to the different seasons of spring, summer, autumn and winter, respectively. The historical load data corresponding to each load type may be historically acquired daily load data generated in a year for the load type.

The first model may be a model of a curve obtained after the historical load data under the corresponding load type is trained according to the above cluster algorithm. A manner of training is basically the same as the manner of clustering and averaging the to-be-classified load data according to the cluster algorithm to obtain the first daily load curve in the above S110, that is, the historical load data is clustered and averaged according to the cluster algorithm to obtain the first model.

The second models may be models corresponding to the different seasons obtained after the historical load data under the corresponding load type is trained according to the above seasonal segmentation aggregation algorithm. A manner of training is basically the same as the manner of segmenting and averaging the to-be-classified load data according to the seasonal segmentation aggregation algorithm to obtain the second daily load curves corresponding to the different seasons in the above S120, that is, the historical load data is segmented and averaged according to the seasonal segmentation aggregation algorithm to obtain the second models corresponding to the different seasons.

When the target daily load curve is separately compared with the daily load curve models corresponding to the different load types, if the target daily load curve is the first daily load curve, the target daily load curve is separately compared with first models under different load types; if the target daily load curve is a second daily load curve corresponding to a certain season, the target daily load curve is separately compared with second models corresponding to the same season under the different load types.

In this step, the target daily load curve is compared with the daily load curve models corresponding to the different load types, and the similarities between the target daily load curve and the daily load curves corresponding to different load types is determined, and a load type corresponding to a daily load curve model with the largest similarity to the target daily load curve is determined as the candidate classification result corresponding to the target daily load curve. The candidate classification result may be a classification result determined for the target daily load curve.

In S140, a target classification result corresponding to the to-be-classified load data is determined according to the candidate classification result.

The target classification result may be a classification result determined for the to-be-classified load data, for example, a user type that generates the to-be-classified load data is determined. In this step, a classification result can be selected from the candidate classification result as the target classification result.

In an embodiment, determining the target classification result corresponding to the to-be-classified load data according to the candidate classification result includes the step described below.

A load type with the highest frequency of occurrence in the candidate classification result is determined as the target classification result corresponding to the to-be-classified load data.

For example, a candidate classification result corresponding to the first daily load curve indicates that a load type is a shopping mall, a candidate classification result of a second daily load curve corresponding to spring indicates that a load type is a shopping mall, a candidate classification result of a second daily load curve corresponding to summer indicates that a load type is a shopping mall, a candidate classification result of a second daily load curve corresponding to autumn indicates that a load type is an office building, a candidate classification result of a second daily load curve corresponding to winter indicates that a load type is a shopping mall, and the shopping mall, which is the load type with the highest frequency of occurrence, is determined as the target classification result corresponding to the to-be-classified load data.

In the technical solution of the embodiment of the present disclosure, the to-be-classified load data is processed according to the cluster algorithm based on the Pearson correlation coefficient to obtain the first daily load curve, where the Pearson correlation coefficient focuses on a variation direction of a curve shape so that a similarity between load curves can be better measured; the to-be-classified load data is processed according to the seasonal segmentation aggregation algorithm to obtain the second daily load curves so that the compression and loss of data features can be reduced to a larger extent while dimensionality reduction is performed on the data; load classification is achieved through the combination of the two algorithms and the comprehensive consideration of the multi-feature models, thereby improving the accuracy of classifying the electrical loads.

### Embodiment Two

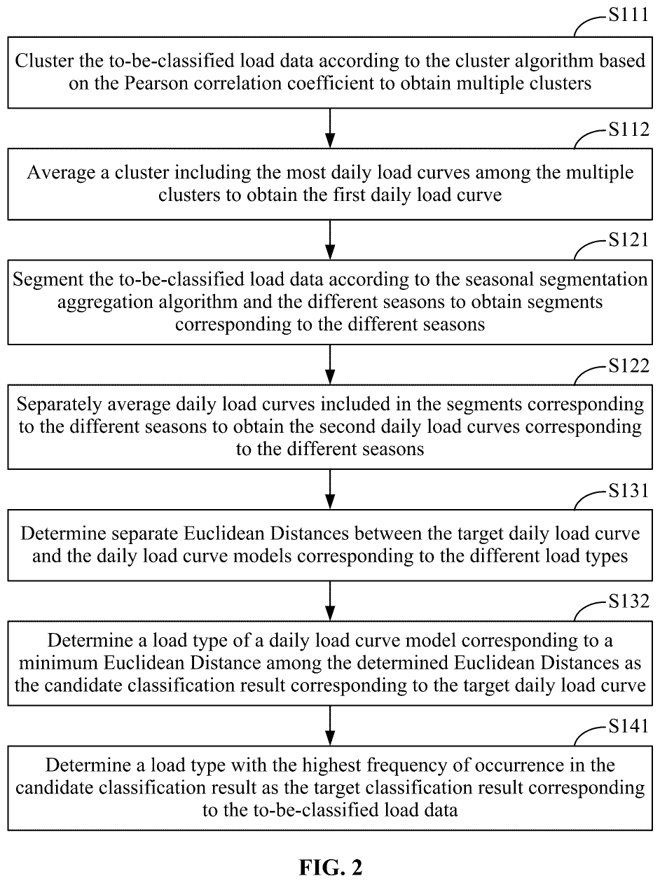

FIG. 2 is a flowchart of a method for classifying electrical loads according to embodiment two of the present disclosure. This embodiment is refined based on the previous embodiment one. As shown in FIG. 2, the method includes S111, S112, S121, S122, S131, S132 and S141.

In S111, the to-be-classified load data is clustered according to the cluster algorithm based on the Pearson correlation coefficient to obtain multiple clusters.

In this step, to-be-classified load data X={X₁, X₂, . . . , Xₙ} is clustered according to the k-means cluster algorithm based on the Pearson correlation coefficient to obtain k clusters C={C₁, C₂, . . . , Cₖ}. X₁, X₂, . . . , Xₙ may be multiple daily load curves included in the to-be-classified load data, where a value of n may be 365 that represents 365 daily load curves. C₁, C₂, . . . , Cₖ may be the multiple clusters obtained after the clustering, where a value of k may be 4 and is not limited here.

A process of the clustering includes the steps described below.

Cluster centers of the k clusters are initialized, distances between each daily load curve and each cluster center are compared in sequence, and each daily load curve is assigned to a cluster with a cluster center closest to the daily load curve to obtain the k clusters.

In a process of assigning each daily load curve to the cluster with the cluster center closest to the daily load curve, a target of the assignment is to minimize an error within clusters. The error within the clusters can be represented by the following formula:

$$E = {\sum }_{i = 1}^{k} {\sum }_{x ∈ {C}_{i}} dist ( x , {μ}_{i} )$$

where E is the error within the clusters; x is a sample that belongs to the cluster Cᵢ, that is, a daily load curve; u; is a cluster center of the cluster Cᵢ; dist denotes a distance between curves.

In the embodiment of the present disclosure, the Pearson correlation coefficient can be used for describing a similarity between curves, that is, dist. The Pearson correlation coefficient can focus on the variation direction of the curve shape, and data does not need to be normalized so that the similarity between the load curves can be better measured. dist can be determined by the following formula:

$$dist ( A , B ) = \frac{cov ( A , B )}{{σ}_{A} {σ}_{B}} = \frac{\sum ( A - \overline{A} ) ( B - \overline{B} )}{( \sqrt{{\sum }_{i}^{p} {( {A}_{i} - \overline{A} )}^{2}} ) ( \sqrt{{\sum }_{i}^{p} {( {B}_{i} - \overline{B} )}^{2}} )}$$

where A and B are two daily load curves whose similarity needs to be measured by the Pearson correlation coefficient, respectively, Aᵢ denotes a load value of each time series on the daily load curve A, Bᵢ denotes a load value of each time series on the daily load curve B, p denotes the number of load values on the daily load curve, Ā denotes an average value of the load value of each time series on the daily load curve A, B̅ denotes an average value of the load value of each time series on the daily load curve B, σA denotes a standard deviation of the daily load curve A, and σB denotes a standard deviation of the daily load curve B.

Since the initial cluster centers according to the k-means cluster method are randomly determined, different initial values may generate different results. Therefore, multiple operations are needed to acquire a stable cluster result.

To obtain a better cluster effect, the cluster result is measured by a contour coefficient here. The contour coefficient is an indicator for measuring the quality of the cluster result. The contour coefficient combines the compactness within clusters and the separation between clusters. The closer the value is to 1, the better the cluster result is. The closer the value is to −1, the worse the cluster result is. A contour coefficient S corresponding to each sample is specifically represented as follows:

$$S = \frac{b - a}{max ( a , b )}$$

where α denotes an average distance between the sample and all other samples in the same cluster, and the smaller the α is, the more the sample should be assigned to the cluster; b denotes a minimum distance between the sample and other clusters, and the larger the b is, the less the sample should be assigned to the other clusters. An average value of contour coefficients corresponding to all samples is calculated to obtain the contour coefficient for the entire cluster result.

Through multiple experiments, a cluster result with a contour coefficient closest to 1 is finally selected, and a cluster including the most daily load curves in the cluster result is set as a commonly used daily load curve set.

It should be noted that a process of acquiring the to-be-classified load data through a power system is susceptible to noises and abnormal data. The data can be preprocessed to improve the quality and accuracy of the data. The preprocessing may include removing invalid or incomplete data and handling missing values, abnormal values and repetition values. A temporal resolution of the daily load curve included in the to-be-classified load data is not limited. For example, the temporal resolution may be in a unit of 15 minutes, 30 minutes or 60 minutes.

In S112, a cluster including the most daily load curves among the multiple clusters is averaged to obtain the first daily load curve.

The commonly used daily load curve set obtained in S111 is averaged to obtain the first daily load curve Y₁. An expression is as follows:

$${Y}_{1} = ( {\sum }_{i}^{m} {X}_{i} ) / m$$

where Xᵢ is a certain daily load curve included in the commonly used daily load curve set, and m is the number of daily load curves included in the commonly used daily load curve set.

In S121, the to-be-classified load data is segmented according to the seasonal segmentation aggregation algorithm and the different seasons to obtain segments corresponding to the different seasons.

The to-be-classified load data X={X₁, X₂, . . . , Xₙ} is divided into four segments U={U₁, U₂, U₃, U₄} according to the seasonal segmentation aggregation algorithm and a time series of spring, summer, autumn and winter.

In S122, daily load curves included in the segments corresponding to the different seasons are separately averaged to obtain the second daily load curves corresponding to the different seasons.

In this step, segmentation aggregation approximation is performed, and the sequence segment is represented by an average value of data elements to obtain second daily load curves Y₂₁, Y₂₂, Y₂₃ and Y₂₄ corresponding to four seasons in sequence, thereby achieving the reduced dimension representation and feature extraction of a daily load curve of a load year. An expression is as follows:

$${Y}_{2 i} = ( {\sum }_{j ∈ {U}_{i}}^{{q}_{i}} {X}_{j} ) / {q}_{i} , i = 1 , 2 , 3 , 4$$

where Xⱼ is a certain daily load curve included in a segment corresponding to a certain season, and qᵢ is the number of daily load curves included in the segment corresponding to the certain season.

In S131, separate Euclidean Distances between the target daily load curve and the daily load curve models corresponding to the different load types are determined.

In this step, a similarity between curves is represented by the Euclidean Distance, and an expression of the Euclidean Distance distₒ is as follows, where Yₒ is the target daily load curve, Yₒᵢ is a load value of each time series on the target daily load curve, X_{Model} is the daily load curve model compared with the target daily load curve, X_{Modeli} is a load value of each time series on the daily load curve model, and t is the number of load values of each time series on the curve.

$${dist}_{o} ( {Y}_{o} , {X}_{Model} ) = \sqrt{{\sum }_{i}^{t} {( {Y}_{oi} - {X}_{Modeli} )}^{2}}$$

In S132, a load type of a daily load curve model corresponding to a minimum Euclidean Distance among the determined Euclidean Distances is determined as the candidate classification result corresponding to the target daily load curve.

In S141, a load type with the highest frequency of occurrence in the candidate classification result is determined as the target classification result corresponding to the to-be-classified load data.

In this step, classification accuracy (CA) and classification average accuracy (CAA) can be used as evaluation indicators of a classification effect corresponding to the target classification result.

In the technical solution of the embodiment of the present disclosure, load classification is achieved according to the k-means cluster algorithm based on the Pearson correlation coefficient and the seasonal segmentation aggregation algorithm, the data does not need to be additionally normalized compared with the traditional k-means cluster method so that the compression and loss of information is reduced and the accuracy of the feature extraction of the data is improved, and the Pearson correlation coefficient can better measure the similarity between the load curves; considering that the power usage of most users has apparent seasonal peak-to-valley characteristics, the seasonal segmentation aggregation algorithm can reduce the compression and loss of the data features to a larger extent while performing the dimensionality reduction on the data compared with a traditional feature representation method based on an average value; using a single method for classifying loads has a limitation, the comprehensive consideration of the multi-feature models improves the accuracy of the classification so that the classification method can adapt to more scenarios and applications.

The present disclosure improves the accuracy and efficiency of the load classification of the power system and ensures the safe and stable operation of the power system, thereby providing a basis for a power department to formulate a power supply plan, perform staggered management and set an electricity price, improving the efficiency and accuracy of the power supply and achieving the safe and stable operation of a power grid.

### Embodiment Three

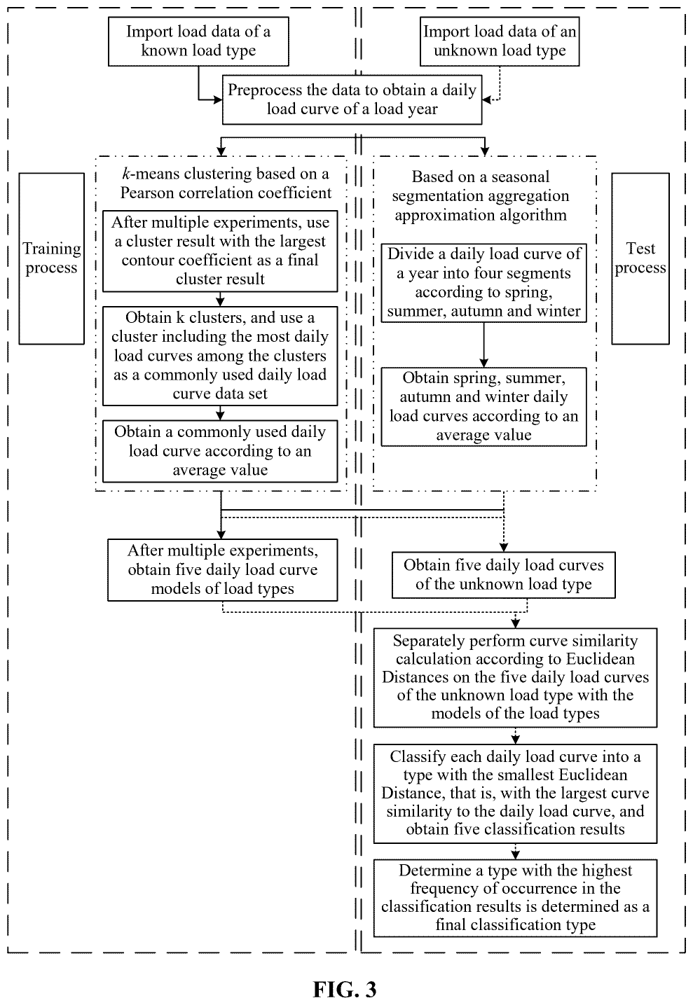

The embodiment of the present disclosure is an exemplary description of the preceding embodiments. FIG. 3 is a flowchart of a method for classifying electrical loads according to embodiment three of the present disclosure.

As shown in FIG. 3, the method includes the steps described below.

A training process is described below. A load type is used as an example for description.

Load data of a known load type is imported, and the data is preprocessed to obtain a daily load curve of a load year, that is, historical load data of the known load type.

The historical load data is processed through k-means clustering based on a Pearson correlation coefficient, and a cluster result with the largest contour coefficient is used as a final cluster result. k clusters are obtained from the cluster result, and a cluster including the most daily load curves among the k clusters is used as a commonly used daily load curve data set. A commonly used daily load curve is obtained according to an average value of the commonly used daily load curve data set, and the commonly used daily load curve is used as a first model.

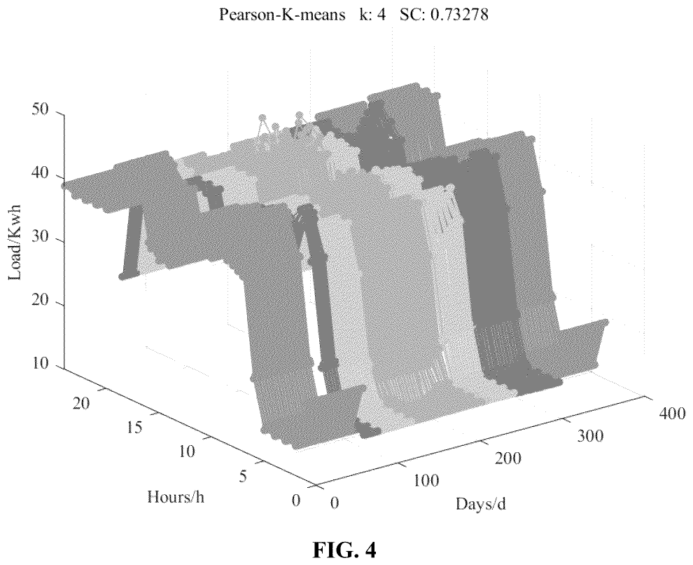

FIG. 4 is a schematic diagram illustrating results of clustering historical load data through k-means clustering based on a Pearson correlation coefficient according to embodiment three of the present disclosure. As can be seen from FIG. 4, four clusters are obtained through the clustering. Different colors in FIG. 4 represent different clusters.

The historical load data is divided into four segments according to spring, summer, autumn and winter through a seasonal segmentation aggregation algorithm. Daily load curves corresponding to spring, summer, autumn and winter, respectively, are obtained according to an average value of each segment, that is, second models corresponding to different seasons.

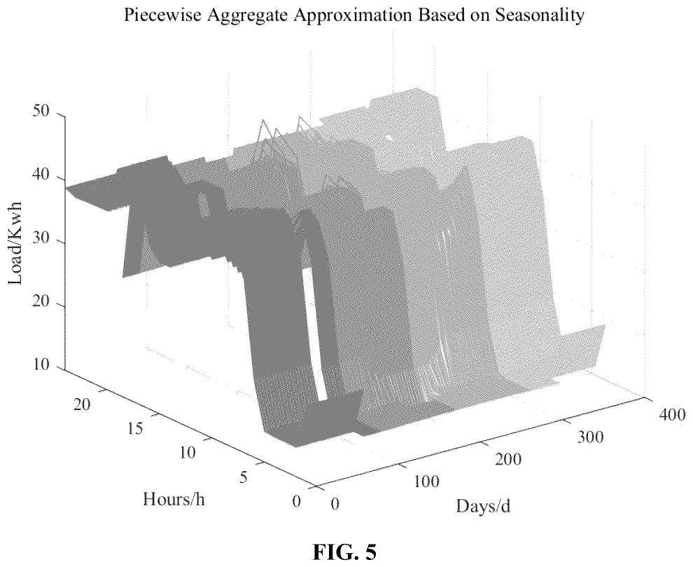

FIG. 5 is a schematic diagram illustrating results of segmenting historical load data through a seasonal segmentation aggregation algorithm according to embodiment three of the present disclosure. In FIG. 5, different colors represent segments corresponding to the different seasons.

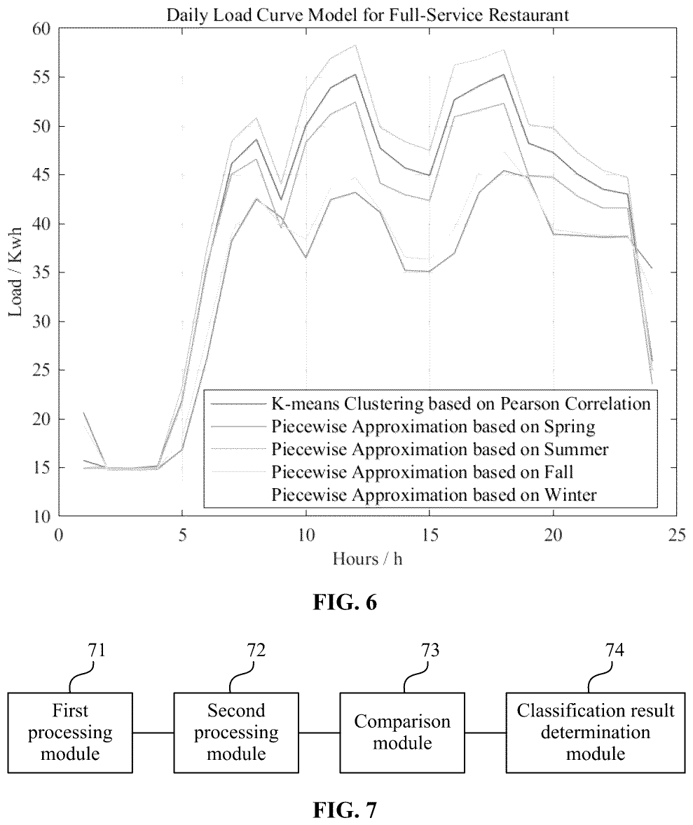

FIG. 6 is a schematic diagram of daily load curve models corresponding to load types according to embodiment three of the present disclosure.

As shown in FIG. 6, the daily load curve models corresponding to the load types obtained through this training include the following five models: k-means clustering based on the Pearson correlation coefficient, that is, the first model; segmentation aggregation approximation based on spring, that is, a second model corresponding to spring; segmentation aggregation approximation based on summer, that is, a second model corresponding to summer; segmentation aggregation approximation based on autumn, that is, a second model corresponding to autumn; and segmentation aggregation approximation based on winter, that is, a second model corresponding to winter.

A test process is described below.

Load data of an unknown load type is imported, and the data is preprocessed to obtain a daily load curve of a load year, that is, to-be-classified load data.

The to-be-classified load data is processed through k-means clustering based on a Pearson correlation coefficient, and a cluster result with the largest contour coefficient is used as a final cluster result. k clusters are obtained from the cluster result, and a cluster including the most daily load curves among the k clusters is used as a commonly used daily load curve data set. A commonly used daily load curve is obtained according to an average value of the commonly used daily load curve data set, and the commonly used daily load curve is used as a first daily load curve.

The to-be-classified load data is divided into four segments according to spring, summer, autumn and winter through a seasonal segmentation aggregation algorithm. Daily load curves corresponding to spring, summer, autumn and winter, respectively, are obtained according to an average value of each segment, that is, second daily load curves corresponding to different seasons.

Five daily load curves of the unknown load type, that is, the first daily load curve and the second daily load curves corresponding to the different seasons, are separately subjected to curve similarity calculation according to Euclidean Distances with the models of the load types (daily load curve models corresponding to different load types). Each daily load curve is classified into a type with the smallest Euclidean Distance, that is, with the largest curve similarity to the daily load curve model, and five classification results (candidate classification results) are obtained. A type with the highest frequency of occurrence in the classification results is determined as a final classification type (a target classification result).

Table 1 shows classification results obtained after a classification test is performed on multiple to-be-classified load data. As shown in Table 1, load classification results of 16 user types are tested, and an effect of each classification result is separately represented by the classification accuracy of the k-means clustering based on the Pearson correlation coefficient, the seasonal segmentation aggregation algorithm and the combination of the two methods.

Table 1 also shows the classification average accuracy of the load classification results of the multiple user types in three classification manners. The method that combines the two methods, that is, the method for classifying electrical loads in the embodiment of the present disclosure, has the highest classification average accuracy. The simulation experiment results verify the effectiveness of the classification according to the method for classifying electrical loads in the embodiment of the present disclosure.

TABLE 1
Classification results obtained after classification test
is performed on multiple to-be-classified load data

| | k-means | | |
|---|---|---|---|
| | Clustering | | |
| | Based on | Seasonal | |
| | the Pearson | Segmentation | Combination |
| | Correlation | Aggregation | of Two |
| User Type | Coefficient | Algorithm | Methods |
| Type 1 | 1 | 1 | 1 |
| Type 2 | 1 | 1 | 1 |
| Type 3 | 1 | 1 | 1 |
| Type 4 | 1 | 1 | 1 |
| Type 5 | 1 | 1 | 1 |
| Type 6 | 0.7 | 1 | 1 |
| Type 7 | 1 | 1 | 1 |
| Type 8 | 1 | 1 | 1 |
| Type 9 | 1 | 1 | 1 |
| Type 10 | 0.6 | 1 | 1 |
| Type 11 | 1 | 1 | 1 |
| Type 12 | 1 | 1 | 1 |
| Type 13 | 1 | 1 | 1 |
| Type 14 | 0.5 | 0.6 | 0.7 |
| Type 15 | 1 | 1 | 1 |
| Type 16 | 1 | 1 | 1 |
| Classification | 0.925 | 0.975 | 0.98125 |
| Average Accuracy | | | |

### Embodiment Four

FIG. 7 is a structure diagram of an apparatus for classifying electrical loads according to embodiment four of the present disclosure. This embodiment may be applicable to the case of classifying electrical loads. As shown in FIG. 7, a specific structure of the apparatus includes a first processing module 71, a second processing module 72, a comparison module 73 and a classification result determination module 74.

The first processing module 71 is configured to cluster and average to-be-classified load data according to a cluster algorithm based on a Pearson correlation coefficient to obtain a first daily load curve, where the to-be-classified load data includes a daily load curve in years.

The second processing module 72 is configured to segment and average the to-be-classified load data according to a seasonal segmentation aggregation algorithm to obtain second daily load curves corresponding to different seasons.

The comparison module 73 is configured to separately compare a target daily load curve with daily load curve models corresponding to different load types to obtain a candidate classification result corresponding to the target daily load curve, where the target daily load curve is any one of the first daily load curve and the second daily load curves.

The classification result determination module 74 is configured to determine a target classification result corresponding to the to-be-classified load data according to the candidate classification result.

In the technical solution provided in the embodiment, the first processing module is configured to cluster and average the to-be-classified load data according to the cluster algorithm based on the Pearson correlation coefficient to obtain the first daily load curve, where the to-be-classified load data includes the daily load curve in years; the second processing module is configured to segment and average the to-be-classified load data according to the seasonal segmentation aggregation algorithm to obtain the second daily load curves corresponding to the different seasons; the comparison module is configured to separately compare the target daily load curve with the daily load curve models corresponding to the different load types to obtain the candidate classification result corresponding to the target daily load curve, where the target daily load curve is any one of the first daily load curve and the second daily load curves; the classification result determination module is configured to determine the target classification result corresponding to the to-be-classified load data according to the candidate classification result. The above technical solution can improve the accuracy of classifying the electrical loads.

Further, the comparison module 73 is specifically configured to perform the operations described below.

Separate Euclidean Distances between the target daily load curve and the daily load curve models corresponding to the different load types are determined.

A load type of a daily load curve model corresponding to a minimum Euclidean Distance among the determined Euclidean Distances is determined as the candidate classification result corresponding to the target daily load curve.

Further, a daily load curve model corresponding to each load type includes a first model obtained after historical load data under the corresponding load type is trained according to the cluster algorithm and second models corresponding to the different seasons obtained after the historical load data is trained according to the seasonal segmentation aggregation algorithm.

The first daily load curve is compared with the first model, and a second daily load curve among the second daily load curves is compared with a second model corresponding to the same season among the second models.

Further, the classification result determination module 74 is specifically configured to perform the operation described below.

A load type with the highest frequency of occurrence in the candidate classification result is determined as the target classification result corresponding to the to-be-classified load data.

Further, the first processing module 71 is specifically configured to perform the operations described below.

The to-be-classified load data is clustered according to the cluster algorithm based on the Pearson correlation coefficient to obtain multiple clusters.

A cluster including the most daily load curves among the multiple clusters is averaged to obtain the first daily load curve.

Further, the second processing module 72 is specifically configured to perform the operations described below.

The to-be-classified load data is segmented according to the seasonal segmentation aggregation algorithm and the different seasons to obtain segments corresponding to the different seasons.

Daily load curves included in the segments corresponding to the different seasons are separately averaged to obtain the second daily load curves corresponding to the different seasons.

The apparatus for classifying electrical loads according to this embodiment of the present disclosure may perform the method for classifying electrical loads according to any embodiment of the present disclosure and has functional modules and beneficial effects corresponding to the performed method.

### Embodiment Five

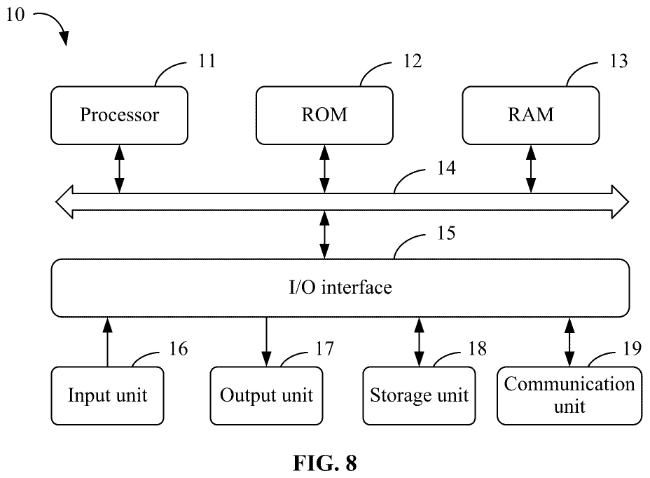

FIG. 8 is a diagram illustrating the structure of an electronic device for implementing any embodiment of the present disclosure. The electronic device is intended to represent various forms of digital computers, for example, a laptop computer, a desktop computer, a worktable, a personal digital assistant, a server, a blade server, a mainframe computer, and an applicable computer. The electronic device may also represent various forms of mobile apparatuses, for example, a personal digital assistant, a cellphone, a smartphone, a wearable device (such as a helmet, glasses, or a watch), and a similar computing apparatus. Herein the shown components, the connections and relationships between these components, and the functions of these components are illustrative only and are not intended to limit the implementation of the present disclosure as described and/or claimed herein.

As shown in FIG. 8, the electronic device 10 includes at least one processor 11 and a memory, such as a read-only memory (ROM) 12 or a random-access memory (RAM) 13, communicatively connected to the at least one processor 11. The memory stores a computer program executable by the at least one processor. The at least one processor 11 may perform various types of appropriate operations and processing according to a computer program stored in a read-only memory (ROM) 12 or a computer program loaded from a storage unit 18 to a random-access memory (RAM) 13. Various programs and data required for the operation of the electronic device 10 may also be stored in the RAM 13. The processor 11, the ROM 12, and the RAM 13 are connected to each other through a bus 14. An I/O interface 15 is also connected to the bus 14.

Multiple components in the electronic device 10 are connected to the I/O interface 15. The multiple components include an input unit 16 such as a keyboard or a mouse, an output unit 17 such as various types of display or speaker, the storage unit 18 such as a magnetic disk or an optical disk, and a communication unit 19 such as a network card, a modem, or a wireless communication transceiver. The communication unit 19 allows the electronic device 10 to exchange information/data with other devices over a computer network such as the Internet and/or various telecommunications networks.

The processor 11 may be various general-purpose and/or special-purpose processing components having processing and computing capabilities. Examples of the processor 11 include, but are not limited to, a central processing unit (CPU), a graphics processing unit (GPU), a special-purpose AI computing chip, a processor executing machine learning models and algorithms, a digital signal processor (DSP), and any appropriate processor, controller, and microcontroller. The processor 11 performs the various methods and processing described above, such as the method for classifying electrical loads.

In some examples, the method for classifying electrical loads may be implemented as computer programs tangibly contained in a computer-readable storage medium such as the storage unit 18. In some embodiments, part or all of computer programs may be loaded and/or installed onto the electronic device 10 via the ROM 12 and/or the communication unit 19. When the computer programs are loaded to the RAM 13 and executed by the processor 11, one or more steps of the preceding method for classifying electrical loads may be performed. Alternatively, in other embodiments, the processor 11 may be configured, in any other suitable manner (for example, by means of firmware), to perform the method for classifying electrical loads.

Herein various embodiments of the preceding systems and techniques may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), computer hardware, firmware, software, and/or combinations thereof. The various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input apparatus, and at least one output apparatus and transmitting data and instructions to the memory system, the at least one input apparatus, and the at least one output apparatus.

Computer programs for implementation of the methods of the present disclosure may be written in one programming language or any combination of multiple programming languages. The computer programs may be provided for a processor of a general-purpose computer, a special-purpose computer, or another programmable data processing apparatus to enable functions/operations specified in a flowchart and/or a block diagram to be implemented when the computer programs are executed by the processor. The computer programs may be executed entirely on a machine, partly on a machine, as a stand-alone software package, partly on a machine and partly on a remote machine, or entirely on a remote machine or a server.

In the context of the present disclosure, the computer-readable storage medium may be a tangible medium including or storing a computer program that is used by or used in conjunction with an instruction execution system, apparatus or device. The computer-readable storage medium may include, but is not limited to, an electronic, magnetic, optical, electromagnetic, infrared, or semiconductor system, apparatus, or device or any appropriate combination thereof. Alternatively, the computer-readable storage medium may be a machine-readable signal medium. Examples of a machine-readable storage medium include an electrical connection based on one or more wires, a portable computer disk, a hard disk, a RAM, a ROM, an erasable programmable read-only memory (EPROM), a flash memory, an optical fiber, a portable compact disc read-only memory (CD-ROM), an optical storage device, a magnetic storage device, or any appropriate combination thereof.

In order that interaction with a user is provided, the systems and techniques described herein may be implemented on the electronic device. The electronic device has a display device for displaying information to the user; and a keyboard and a pointing device (for example, a mouse or a trackball) through which the user can provide input for the electronic device. Other types of apparatuses may also be used for providing interaction with a user. For example, feedback provided for the user may be sensory feedback in any form (for example, visual feedback, auditory feedback, or tactile feedback); and input from the user may be received in any form (including acoustic input, voice input, or tactile input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with embodiments of the systems and techniques described herein), or a computing system including any combination of such back-end, middleware, or front-end components. Components of a system may be interconnected by any form or medium of digital data communication (for example, a communication network). Examples of the communication network include a local area network (LAN), a wide area network (WAN), a blockchain network, and the Internet.

The computing system may include clients and servers. A client and a server are generally remote from each other and typically interact through a communication network. The relationship between the client and the server arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in a related physical host and a related virtual private server (VPS).

It is to be understood that various forms of the preceding flows may be used with steps reordered, added, or deleted. For example, the steps described in the present disclosure may be performed in parallel, in sequence, or in a different order as long as the desired result of the technical solutions provided in the present disclosure can be achieved. The execution sequence of these steps is not limited herein.

The preceding embodiments are not intended to limit the scope of the present application. It is to be understood by those skilled in the art that various modifications, combinations, subcombinations, and substitutions may be made according to design requirements and other factors. Any modification, equivalent substitution, or improvement made within the spirit and principle of the present disclosure fall within the scope of the present disclosure.

What is claimed is:

1. A method for classifying electrical loads, comprising:
clustering and averaging to-be-classified load data according to a cluster algorithm based on a Pearson correlation coefficient to obtain a first daily load curve, wherein the to-be-classified load data comprises a daily load curve in years;
segmenting and averaging the to-be-classified load data according to a seasonal segmentation aggregation algorithm to obtain second daily load curves corresponding to different seasons;
separately comparing a target daily load curve with daily load curve models corresponding to different load types to obtain a candidate classification result corresponding to the target daily load curve, wherein the target daily load curve is any one of the first daily load curve and the second daily load curves; and
determining a target classification result corresponding to the to-be-classified load data according to the candidate classification result.

2. The method according to claim 1, wherein separately comparing the target daily load curve with the daily load curve models corresponding to the different load types to obtain the candidate classification result corresponding to the target daily load curve comprises:
determining separate Euclidean Distances between the target daily load curve and the daily load curve models corresponding to the different load types; and
determining a load type of a daily load curve model corresponding to a minimum Euclidean Distance among the determined Euclidean Distances as the candidate classification result corresponding to the target daily load curve.

3. The method according to claim 1, wherein:
a daily load curve model corresponding to each load type comprises a first model obtained after historical load data under the corresponding load type is trained according to the cluster algorithm and second models corresponding to the different seasons obtained after the historical load data is trained according to the seasonal segmentation aggregation algorithm; and
the first daily load curve is compared with the first model, and a second daily load curve among the second daily load curves is compared with a second model corresponding to a same season among the second models.

4. The method according to claim 1, wherein determining the target classification result corresponding to the to-be-classified load data according to the candidate classification result comprises:
determining a load type with a highest frequency of occurrence in the candidate classification result as the target classification result corresponding to the to-be-classified load data.

5. The method according to claim 1, wherein clustering and averaging the to-be-classified load data according to the cluster algorithm based on the Pearson correlation coefficient to obtain the first daily load curve comprises:
clustering the to-be-classified data according to the cluster algorithm based on the Pearson correlation coefficient to obtain a plurality of clusters; and
averaging a cluster comprising the most daily load curves among the plurality of clusters to obtain the first daily load curve.

6. The method according to claim 1, wherein segmenting and averaging the to-be-classified load data according to the seasonal segmentation aggregation algorithm to obtain the second daily load curves corresponding to the different seasons comprises:
segmenting the to-be-classified load data according to the seasonal segmentation aggregation algorithm and the different seasons to obtain segments corresponding to the different seasons; and
separately averaging daily load curves comprised in the segments corresponding to the different seasons to obtain the second daily load curves corresponding to the different seasons.

7. An electronic device, comprising:
at least one processor; and
a memory communicatively connected to the at least one processor;
wherein the memory stores a computer program executable by the at least one processor to enable the at least one processor to perform the method according to claim 1.

8. A non-transitory computer-readable storage medium, which is configured to store a computer instruction which, when executed by a processor, causes the processor to implement the method according to claim 1.

9. A computer program product, comprising a computer program, wherein the computer program is configured to, when executed by a processor, implement the method according to claim 1.
